(19) United States
(12) Patent Application Publication
(10) Pub. No.: US 2025/0103234 A1
(43) Pub. Date: Mar. 27, 2025

(54) LSM TREE-BASED DATA STORAGE METHOD AND RELATED DEVICE

(71) Applicant: Alipay (Hangzhou) Information Technology Co., Ltd., Hangzhou (CN)

(72) Inventors: Ren LI, Hangzhou (CN); Zigang ZHANG, Hangzhou (CN)

(21) Appl. No.: 18/897,506

(22) Filed: Sep. 26, 2024

(30) Foreign Application Priority Data
Sep. 27, 2023 (CN) 202311272604.7

(51) Int. Cl. G06F 3/06; G06F 16/22

(52) U.S. Cl. CPC G06F 3/0649; G06F 3/0611; G06F 3/0641; G06F 3/0674; G06F 16/2246

(57) ABSTRACT

This specification provides an LSM tree-based data storage method and a related device, applied to an LSM tree-based data storage system. The method includes: determining whether the first storage layer meets a merge condition for merging with the second storage layer, and if yes, selecting a to-be-merged target file from the at least one first file stored at the first storage layer, where the target file includes data corresponding to a target type; and searching the plurality of second sub-files for a target sub-file that includes data corresponding to the target type, and merging the target file and the target sub-file.

### TECHNICAL FIELD

One or more embodiments of this specification relate to the field of data storage technologies, and in particular, to an LSM tree-based data storage method and a related device.

### BACKGROUND

A log-structured merge tree (LSM Tree) is a multi-layer storage structure, and is usually applied to a key-value (key-value) data storage system. Through the LSM tree, data in a memory can be written into a disk in batches and in an orderly manner in the form of files, and a merge operation can be automatically performed on files at layers on the disk to reduce duplicate data. In a process of merging an upper-layer file and a lower-layer file on the disk, the lower-layer file is usually searched for a file that includes data of a same key as the upper-layer file, and the file and the upper-layer file are merged.

However, the lower-layer file usually includes data respectively corresponding to a plurality of keys, that is, only a small part of data in the lower-layer file may have a same key as data in the upper-layer file. In this case, a large amount of unnecessary data is passively merged, which causes severe read/write amplification, and further affects storage performance of the disk.

### SUMMARY

In view of this, one or more embodiments of this specification provide an LSM tree-based data storage method and a related device.

According to a first aspect, this specification provides an LSM tree-based data storage method, applied to an LSM tree-based data storage system. An LSM tree includes a plurality of storage layers. At least one first file is stored at a first storage layer in the plurality of storage layers. A plurality of second sub-files obtained by dividing a second file are stored at a second storage layer in the plurality of storage layers, the second file includes data respectively corresponding to a plurality of types, and each of the plurality of second sub-files includes data corresponding to a same type. The method includes:
determining whether the first storage layer meets a merge condition for merging with the second storage layer, and if yes, selecting a to-be-merged target file from the at least one first file stored at the first storage layer, where the target file includes data corresponding to a target type; and
searching the plurality of second sub-files stored at the second storage layer for a target sub-file that includes data corresponding to the target type, and merging the target file and the target sub-file.

According to a second aspect, this specification provides an LSM tree-based data storage apparatus, applied to an LSM tree-based data storage system. An LSM tree includes a plurality of storage layers. At least one first file is stored at a first storage layer in the plurality of storage layers. A plurality of second sub-files obtained by dividing a second file are stored at a second storage layer in the plurality of storage layers, the second file includes data respectively corresponding to a plurality of types, and each of the plurality of second sub-files includes data corresponding to a same type. The apparatus includes:
a determining unit, configured to: determine whether the first storage layer meets a merge condition for merging with the second storage layer, and if yes, select a to-be-merged target file from the at least one first file stored at the first storage layer, where the target file includes data corresponding to a target type; and
a merge unit, configured to: search the plurality of second sub-files stored at the second storage layer for a target sub-file that includes data corresponding to the target type, and merge the target file and the target sub-file.

Correspondingly, this specification further provides a computer device, including a memory and a processor. The memory stores a computer program capable of being run by the processor, and when the processor runs the computer program, the LSM tree-based data storage method is performed.

Correspondingly, this specification further provides a non-transitory computer-readable storage medium. The non-transitory computer-readable storage medium stores a computer program, and when the computer program is run by a processor, the LSM tree-based data storage method is performed.

In conclusion, this specification is applied to an LSM tree-based data storage system, and an LSM tree can include a plurality of storage layers. At least one first file can be stored at a first storage layer in the plurality of storage layers. A plurality of second sub-files obtained by dividing a second file are stored at a second storage layer in the plurality of storage layers, the second file can include data respectively corresponding to a plurality of types, and each of the plurality of second sub-files obtained through division can include only data corresponding to a same type. First, in this specification, it can be first determined whether the first storage layer meets a merge condition for merging with the second storage layer, and if yes, a to-be-merged target file can be selected from the at least one first file stored at the first storage layer. The target file can include data corresponding to a target type. Further, in this specification, the plurality of second sub-files stored at the second storage layer can be searched for a target sub-file that includes data corresponding to the target type, and a merge operation is performed on the target file and the target sub-file. In this way, in this specification, a file that includes data corresponding to a plurality of types is divided into a plurality of sub-files, and each sub-file includes only data corresponding to a same type. Therefore, in a process of merging an upper-layer file and a lower-layer file in the LSM tree, passive participation of different types of data in merging is effectively avoided, thereby greatly reducing a read/write amplification amount during merging, and improving storage performance.

### BRIEF DESCRIPTION OF DRAWINGS

FIG. 1 is a schematic diagram of a storage structure of an LSM tree according to an example embodiment;

FIG. 2 is a schematic diagram of an architecture of an LSM tree-based data storage system according to an example embodiment;

FIG. 3 is a schematic flowchart of an LSM tree-based data storage method according to an example embodiment;

FIG. 4 is a schematic diagram of a file merging procedure according to an example embodiment;

FIG. 5 is a schematic diagram of another file merging procedure according to an example embodiment;

FIG. 6 is a schematic structural diagram of an LSM tree-based data storage apparatus according to an example embodiment; and

FIG. 7 is a schematic structural diagram of a computer device according to an example embodiment.

### DESCRIPTION OF EMBODIMENTS

Example embodiments are described in detail herein, and examples of the example embodiments are presented in the accompanying drawings. When the following descriptions relate to the accompanying drawings, unless specified otherwise, same numbers in different accompanying drawings represent same or similar elements. Implementations described in the following example embodiments do not represent all implementations consistent with one or more embodiments of this specification. On the contrary, the implementations are merely examples of apparatuses and methods that are described in the appended claims in detail and consistent with some aspects of one or more embodiments of this specification.

It should be noted that the steps of the corresponding method are not necessarily performed in the sequence shown and described in this specification in other embodiments. In some other embodiments, the method can include more or fewer steps than those described in this specification. In addition, a single step described in this specification may be decomposed into a plurality of steps in other embodiments for description; and a plurality of steps described in this specification may be combined into a single step in other embodiments for description.

It should be noted that “a plurality of” in this specification means two or more.

In addition, user information (including but not limited to user equipment information, personal user information, and the like) and data (including but not limited to data used for analysis, stored data, displayed data, and the like) in this specification are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.
(1) A log-structured merge tree (LSM Tree) is a multi-layer storage structure, and is usually applied to a key-value (key-value) data storage system. Through the LSM tree, data in a memory can be written into a disk in batches and in an orderly manner, and a merge operation can be automatically performed on files at layers on the disk to reduce duplicate data. Details are not described herein.

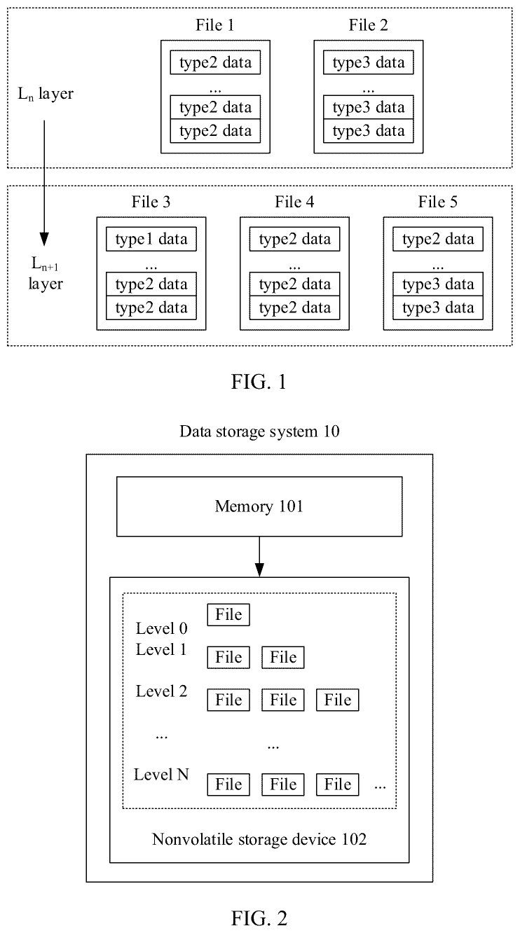

FIG. 1 is a schematic diagram of a storage structure of an LSM tree according to an example embodiment.

As shown in FIG. 1, a file 1 and a file 2 are stored at an Lₙ layer in a disk. The file 1 includes only data corresponding to type2, and the file 2 includes only data corresponding to type3.

In a shown implementation, a key of key-value data can include only the above-mentioned type. For example, in the data included in the file 1, a key of each piece of data is type2, that is, the file 1 includes only data whose key is type2. For example, in the data included in the file 2, a key of each piece of data is type3, that is, the file 2 includes only data whose key is type3. In a shown implementation, in addition to the type, the key of the key-value data can further include an id, a timestamp, and the like. This is not specifically limited in this specification.

The following provides descriptions by using an example in which the key includes only the type (that is, key=type).

As shown in FIG. 1, a file 3, a file 4, and a file 5 are stored at an Lₙ₊₁ layer in the disk. The file 3 includes both data whose key is type1 and data whose key is type2, the file 4 includes only data whose key is type2, and the file 5 includes both data whose key is type2 and data whose key is type3.

It should be noted that the files 1 to 5 can be referred to as sorted sequence table (SST) files. An SST is a persistent, ordered, and immutable key-value storage structure, and both a key and a value of the SST are any byte arrays. Data in each SST file is ordered by key. For example, the data included in the file 3 can be arranged in an orderly manner in a sequence of keys type1 and type2, and the data included in the file 5 can be arranged in an orderly manner in a sequence of keys type2 and type3.

As described above, in the multi-layer storage structure of LSM, if the Lₙ layer in the disk meets a merge condition (for example, a total data amount of all files stored at the Lₙ layer is greater than a storage capacity threshold of the layer), a to-be-merged file is selected from all the files stored at the Ln layer to move to the Lₙ₊₁ layer, and is merged with a file at the Lₙ₊₁ layer, to reduce duplicate data. For example, a first-written file (or an oldest file) at the Lₙ layer is usually selected as the to-be-merged file. Specifically, when file merging is performed, the Lₙ₊₁ layer is first searched for a file that has an overlapping key with the to-be-merged file at the Lₙ layer to participate in merging. For example, the file 1 at the Lₙ layer is the to-be-merged file. As shown in FIG. 1, all of the file 3, the file 4, and the file 5 at the Lₙ₊₁ layer include data whose key is type2, that is, all of the file 3, the file 4, and the file 5 overlap the file 1. Therefore, all of the file 3, the file 4, and the file 5 participate in merging with the file 1. Specifically, when a merge operation is performed, all data included in the file 1, the file 3, the file 4, and the file 5 that participate in merging is usually first read, duplicate data with a same value is deleted from all the data, then merging is performed based on remaining data to obtain a new file, and then the new file is written into the Lₙ₊₁ layer.

Clearly, in the above-mentioned conventional solution, the data whose key is type1 in the file 3 and the data whose key is type3 in the file 5 passively participate in merging, and merging of the unnecessary data inevitably causes unnecessary read/write amplification. Particularly in the case of frequent file updates, a large quantity of files are frequently written into the disk, and are sequentially moved to lower layers, which triggers a large quantity of merge operations, resulting in severe read/write amplification.

Based on this, this specification provides a technical solution in which a file that is stored in an LSM tree and that includes data corresponding to a plurality of types is divided. Therefore, when an upper-layer file and a lower-layer file in the LSM tree are subsequently merged, passive participation of unnecessary data in file merging can be effectively avoided, thereby greatly reducing a read/write amplification amount in a file merging process.

In implementation, this specification can be applied to an LSM tree-based data storage system. An LSM tree can include a plurality of storage layers. At least one first file is stored at a first storage layer in the plurality of storage layers. A plurality of second sub-files obtained by dividing a second file are stored at a second storage layer in the plurality of storage layers, the second file can include data respectively corresponding to a plurality of types, and each of the plurality of second sub-files can include data corresponding to a same type. First, in this specification, it can be determined whether the first storage layer meets a merge condition for merging with the second storage layer, and if yes, a to-be-merged target file can be selected from the at least one first file stored at the first storage layer. The target file can include data corresponding to a target type. Then, in this specification, the plurality of second sub-files can be searched for a target sub-file that includes data corresponding to the target type, and the target file and the target sub-file can be merged.

In the above-mentioned technical solution, in this specification, a file that includes data corresponding to a plurality of types is divided into a plurality of sub-files, and each sub-file includes only data corresponding to a same type. Therefore, in a process of merging an upper-layer file and a lower-layer file in the LSM tree, passive participation of different types of data in merging is effectively avoided, thereby greatly reducing a read/write amplification amount during merging, and improving storage performance.

FIG. 2 is a schematic diagram of an architecture of an LSM tree-based data storage system according to an example embodiment. One or more embodiments provided in this specification can be specifically implemented in the system architecture shown in FIG. 2 or a similar system architecture. As shown in FIG. 2, the LSM tree-based data storage system can include a memory 101 and a nonvolatile storage device 102.

The memory 101 can be used as a first storage layer in a plurality of storage layers in an LSM tree, where all recently written key-value data is stored, and can be updated locally at any time, and query is supported at any time.

The nonvolatile storage device 102 can include a plurality of storage layers used to store data. As shown in FIG. 2, the nonvolatile storage device 102 can specifically include a level-0 layer to a level-N layer. Storage capacities of storage layers in the nonvolatile storage device 102 usually gradually increase from the level-0 layer to the level-N layer, and a storage capacity of each layer can be 10 times that of a previous layer. This is not specifically limited in this specification. For example, the nonvolatile storage device 102 can be, for example, a hard disk or a disk. This is not specifically limited in this specification.

In a shown implementation, data in the memory 101 can be first written into the level-0 layer in the nonvolatile storage device 102 in the form of files. A size of each file can be fixed, for example, 4M or 2M. When a current file is full, remaining data is subsequently written into a next file, and so on. Details are not described herein.

In a shown implementation, if a file written into the nonvolatile storage device 102 includes data corresponding to a plurality of keys, the file can be divided into a plurality of sub-files in this specification. Each of the plurality of sub-files includes only data corresponding to a same key.

For example, the level-0 layer shown in FIG. 2 is the Ln layer in FIG. 1, and the level-1 layer is the Lₙ₊₁ layer in FIG. 1. In this case, files stored at the level-0 layer can include the file 1 and the file 2 shown in FIG. 1, and files stored at the level-1 layer can include the file 3, the file 4, and the file 5 shown in FIG. 1. The file 3 includes both data whose key is type1 and data whose key is type2. Based on this, in this specification, the file 3 can be divided into two sub-files to obtain a file 3-1 and a file 3-2. The file 3-1 includes only data whose key is type1 (that is, key=type1), and the file 3-2 includes only data whose key is type2. Similarly, in this specification, the file 5 can be divided into two sub-files to obtain a file 5-1 and a file 5-2. The file 5-1 includes only data whose key is type2, and the file 5-2 includes only data whose key is type3.

Further, when the level-0 layer shown in FIG. 2 meets a merge condition (for example, a total data amount of all files stored at the level-0 layer is greater than a storage capacity threshold of the level-0 layer) for merging with the level-1 layer, and the file 1 is selected as a to-be-merged file, based on the fact that all of the file 3-2, the file 4, and the file 5-1 that are currently stored at the level-1 layer include data with the same key type2 as the file 1, in this specification, the file 1 can be merged with the file 3-2, the file 4, and the file 5-1 at the level-1 layer, and the file 3-1 and the file 5-2 do not need to participate in merging. Correspondingly, at least one new file obtained after the file 1 is merged with the file 3-2, the file 4, and the file 5-1 can be stored at the level-1 layer.

In a shown implementation, in this specification, the file 3 and the file 5 can be divided after the file 3 and the file 5 are written into the level-0 layer from the memory 101. In a shown implementation, in this specification, the file 3 and the file 5 can be divided in response to a merge operation performed on the file 1, and so on. This is not specifically limited in this specification. For details, refer to descriptions of subsequent embodiments. Details are not described herein.

In addition, it can be understood that a quantity of new files obtained through merging depends on a data amount threshold of a file and a data amount of duplicate data included in a file that participates in merging.

For example, a data amount threshold of each file is 4M. Each of the file 1 and the file 4 includes 4M data whose key is type2, the file 3-2 obtained through merging includes 2M data whose key is type2, and the file 5-1 obtained through merging includes IM data whose key is type2, that is, the file 1, the file 3-2, the file 4, and the file 5-1 include a total of 11M data. However, there may be 5M duplicate data in all the 11M data included in the file 1, the file 3-2, the file 4, and the file 5-1. Based on the remaining 6M data, two new files can be obtained through merging. One of the new files includes 4M data, and the other new file can include 2M data.

For example, a data amount threshold of each file is 4M. Each of the file 1 and the file 4 includes 4M data whose key is type2, the file 3-2 obtained through merging includes 2M data whose key is type2, and the file 5-1 obtained through merging includes 2M data whose key is type2, that is, the file 1, the file 3-2, the file 4, and the file 5-1 include a total of 12M data. However, there may be IM duplicate data in all the 12M data included in the file 1, the file 3-2, the file 4, and the file 5-1. Based on the remaining 11M data, three new files can be obtained through merging. Two of the new files can each include 4M data, and the other new file can include 3M data. This is not specifically limited in this specification.

In this way, in this specification, a file that is stored in an LSM tree and that includes data corresponding to a plurality of keys is divided. Therefore, when an upper-layer file and a lower-layer file in the LSM tree are subsequently merged, passive participation of unnecessary data in file merging can be effectively avoided, thereby greatly reducing a read/write amplification amount in a file merging process.

It should be noted that selection of the to-be-merged file usually starts from the level-0 layer in the disk for file down-migration and merging. If no file at the level-0 layer can be down migrated, or there is space in a storage capacity of the level-0 layer, that is, a total data amount of all files stored at the level-0 layer is less than a storage capacity threshold of the level-0 layer, an appropriate storage layer can be selected from the level-1 layer to the level-N−1 layer for file down-migration and merging.

It should be noted that a specific implementation of selecting an appropriate storage layer from the level-1 layer to the level-N−1 layer is not specifically limited in this specification.

In a shown implementation, it can be determined whether a total data amount of all files stored at each storage layer in the level-1 layer to the level-N−1 layer is greater than a storage capacity threshold of each storage layer. If yes, the to-be-merged file can be selected from a file stored at the storage layer for down-migration and merging.

In a shown implementation, a ratio of a total data amount of all files stored at each storage layer in the level-1 layer to the level-N−1 layer to a storage capacity threshold of each storage layer can be first calculated. Further, file down-migration and merging can be performed starting from a storage layer with a largest ratio, and so on. This is not specifically limited in this specification.

It should be noted that a specific type of the LSM tree-based data storage system is not specifically limited in this specification.

In a shown implementation, the LSM tree-based data storage system can be a key-value storage database system. For example, a key-value storage database can be a Redis database, a Memcached database, an Apache Ignite database, a Riak database, or the like. This is not specifically limited in this specification.

In a shown implementation, the LSM tree-based data storage system can alternatively be a graph database system or a storage engine in a graph database system. For example, a graph database can be a GeaBase graph database, or the like. This is not specifically limited in this specification.

In addition, in some possible implementations, the LSM tree-based data storage system can alternatively be a relational database system constructed based on key-value storage. This is not specifically limited in this specification.

It should be understood that FIG. 2 is merely an example for description. In some possible implementations, the LSM tree-based data storage system can further include more or fewer structures than those shown in FIG. 1, for example, can further include a CPU connected to the memory, and the like. This is not specifically limited in this specification.

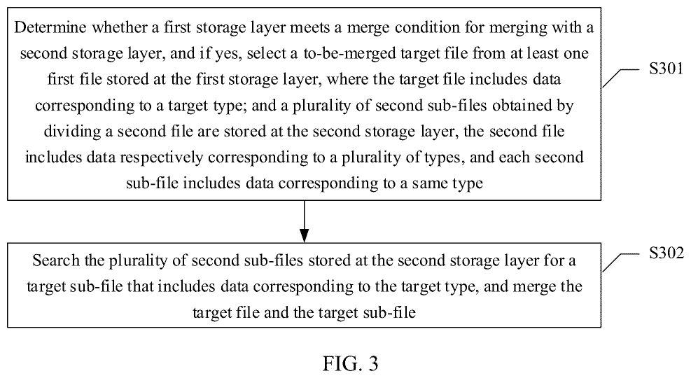

FIG. 3 is a schematic flowchart of an LSM tree-based data storage method according to an example embodiment. The method can be applied to the LSM tree-based data storage system shown in FIG. 2, and an LSM tree can include a plurality of storage layers. As shown in FIG. 3, the method can specifically include the following steps S301 and S302.

Step S301: Determine whether a first storage layer meets a merge condition for merging with a second storage layer, and if yes, select a to-be-merged target file from at least one first file stored at the first storage layer, where the target file includes data corresponding to a target type; and a plurality of second sub-files obtained by dividing a second file are stored at the second storage layer, the second file includes data respectively corresponding to a plurality of types, and each second sub-file includes data corresponding to a same type.

In a shown implementation, in the plurality of storage layers included in the LSM tree, the at least one first file can be stored at the first storage layer, and the plurality of second sub-files obtained by dividing the second file can be stored at the second storage layer. The second file can include the data respectively corresponding to the plurality of types. Correspondingly, each of the plurality of second sub-files obtained by dividing the second file can include only data corresponding to a same type.

A data amount included in each file (for example, the first file, the second file, and the second sub-file obtained through division) stored at the storage layer is usually less than or equal to a first preset threshold. For example, the first preset threshold can be 4M, 2M, 8M, or the like. This is not specifically limited in this specification.

In a shown implementation, the second storage layer can be a next layer adjacent to the first storage layer.

In a shown implementation, the first storage layer can be a memory, and the second storage layer can be a first layer in a disk. For example, referring to FIG. 2, the first storage layer can be the memory 101 shown in FIG. 2, and the second storage layer can be the level-0 layer in the nonvolatile storage device 102 shown in FIG. 2.

In a shown implementation, the first storage layer and the second storage layer can alternatively be adjacent upper and lower layers in a disk. For example, referring to FIG. 2, the first storage layer can be the level-0 layer in the nonvolatile storage device 102 shown in FIG. 2, and the second storage layer can be the level-1 layer. For example, the first storage layer can be the level-1 layer in the nonvolatile storage device 102, and the second storage layer can be the level-2 layer, and so on. This is not specifically limited in this specification.

In a shown implementation, the dividing the second file can specifically include: reading the data that is included in the second file and that respectively corresponds to the plurality of types; and then generating the plurality of second sub-files corresponding to the plurality of types based on the read data respectively corresponding to the plurality of types, and separately writing the plurality of second sub-files into the second storage layer.

In a shown implementation, the data in the file can be data of a key-value structure. Correspondingly, a key of the data can include the type.

In a shown implementation, the key of the data can include only the type.

In a shown implementation, the key of the data can include the type and an id. Correspondingly, an encoding manner of the key can be type+id, that is, the key is encoded in a manner in which the type is before the id, so that the type in the data can be subsequently quickly and efficiently read, and the file can be divided based on the type.

In a shown implementation, the key of the data can include the type, an id, and a timestamp. Correspondingly, an encoding manner of the key can be type+id+timestamp, that is, the key is encoded in a manner in which the type is before the id and the timestamp that are in a sequence, so that the type in the data can be subsequently quickly and efficiently read, and the file can be divided based on the type.

The following still provides descriptions by using an example in which the key includes only the type (that is, key-type).

For example, the second file includes data respectively corresponding to type1, type2, and type3, and the second file is divided to obtain a corresponding second sub-file 1, a corresponding second sub-file 2, and a corresponding second sub-file 3. The second sub-file 1 includes only data corresponding to type1, the second sub-file 2 includes only data corresponding to type2, and the second sub-file 3 includes only data corresponding to type3. Further, the second sub-file 1, the second sub-file 2, and the second sub-file 3 obtained through division can be separately written into the second storage layer. Correspondingly, the original second file can be deleted from the second storage layer.

For example, type1, type2, and type3 can represent different merchant IDs. Correspondingly, the data respectively corresponding to type1, type2, and type3 can represent transaction order data or merchant information of different merchants, or the like. This is not specifically limited in this specification.

For example, type1, type2, and type3 can represent different employee IDs. Correspondingly, the data respectively corresponding to type1, type2, and type3 can represent basic employee information or performance assessment data of different employees, or the like. This is not specifically limited in this specification.

In a shown implementation, when data is stored by using the LSM tree, in this specification, it can be determined whether the first storage layer in the LSM tree meets the merge condition for merging with the second storage layer.

It should be noted that specific content of the merge condition is not specifically limited in this specification. In a shown implementation, the merge condition can include: a total data amount of the at least one first file stored at the first storage layer is greater than a second preset threshold. The second preset threshold can be a storage capacity threshold of the first storage layer, for example, can be 64M, 1GB, or 2GB. This is not specifically limited in this specification.

In a shown implementation, if the first storage layer meets the merge condition for merging with the second storage layer, in this specification, the to-be-merged target file can be selected from the at least one first file stored at the first storage layer. The target file can include the data corresponding to the target type.

In a shown implementation, the type can be a hot data type or a non-hot data type. In a shown implementation, the target type can be the hot data type, for example, a merchant that frequently makes a transaction.

It should be noted that a specific implementation of selecting the to-be-merged target file from the at least one first file is not specifically limited in this specification.

In a shown implementation, the to-be-merged target file can be a file first written into the first storage layer, that is, an oldest file. In a shown implementation, the to-be-merged target file can alternatively be a file last written into the first storage layer, that is, a latest file. In a shown implementation, the to-be-merged target file can alternatively be a file that includes a largest data amount or a file that includes a smallest data amount at the first storage layer, or the like. This is not specifically limited in this specification.

In addition, it should be noted that a trigger condition for dividing the second file is not specifically limited in this specification.

In a shown implementation, in response to writing the second file into the second storage layer, and the second file including the data respectively corresponding to the plurality of types, in this specification, the second file can be immediately divided to obtain the plurality of second sub-files corresponding to the plurality of types, and the plurality of second sub-files are stored at the second storage layer. Correspondingly, the original second file can be deleted from the second storage layer.

In a shown implementation, after the second file is written into the second storage layer, division may not be performed first. Further, in response to the to-be-merged target file selected from the first storage layer including the data corresponding to the target type, and the plurality of types included in the second file including the target type, in this specification, the second file can be divided to obtain the plurality of second sub-files corresponding to the plurality of types. A target sub-file in the plurality of second sub-files obtained through division can include only data corresponding to the target type.

Step S302: Search the plurality of second sub-files stored at the second storage layer for a target sub-file that includes data corresponding to the target type, and merge the target file and the target sub-file.

Further, in response to the first storage layer meeting the merge condition for merging with the second storage layer, after the to-be-merged target file is selected from the at least one first file stored at the first storage layer, in this specification, the plurality of second sub-files stored at the second storage layer can be searched for the target sub-file that includes data corresponding to the target type.

Further, in this specification, merge processing can be performed on the target file and the target sub-file, and at least one file obtained after merging is written into the second storage layer. Correspondingly, the original target file and target sub-file can be deleted.

In a shown implementation, the merging the target file and the target sub-file can specifically include: reading the data that is included in the target file and the target sub-file and that corresponds to the target type; and then deleting duplicate data from the data. Further, at least one corresponding file can be generated based on remaining data in the data, and the at least one file can be written into the second storage layer. A data amount included in each of the at least one file obtained after merging can be less than or equal to the above-mentioned first preset threshold.

The following describes in detail, by using an example, file division and file merging in the data storage method provided in this specification.

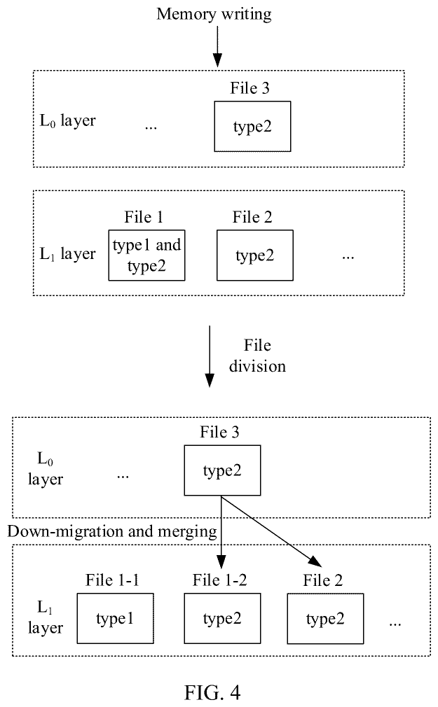

FIG. 4 is a schematic diagram of a file merging procedure according to an example embodiment. For example, an LSM tree includes three storage layers, and the three storage layers can include a memory and an L₀ layer and an L₁ layer in a disk. As shown in FIG. 4, data in the memory can be written into the L₀ layer in the disk in the form of files. When the L₀ layer meets a merge condition (for example, a total data amount of files stored at the L₀ layer is greater than the above-mentioned second preset threshold) for merging with the L₁ layer, the file at the L₀ layer can be down migrated to the L₁ layer, and merged with a file at the L₁ layer, to reduce duplicate data and improve data storage performance.

As shown in FIG. 4, in this case, a file 1, a file 2, and the like are stored at the L₁ layer in the disk, and a file 3 and the like are stored at the L₀ layer. The file 1 includes data whose key is type1 and data whose key is type2, the file 2 includes only data whose key is type2, and the file 3 includes only data whose key is type2.

For example, the file 3 first written into the L₀ layer can be selected as a to-be-merged file in response to the L₀ layer meeting the merge condition. As shown in FIG. 4, because the file 3 includes data whose key is type2, the file 1 can be divided to obtain a file 1-1 and a file 1-2. The file 1-1 includes only data whose key is type1, and the file 1-2 includes only data whose key is type2.

Further, after the file 1-1 and the file 1-2 are obtained through division, the file 3 and the file 1-2 and the file 2 that include data whose key is type2 at the L₁ layer can be merged in this specification.

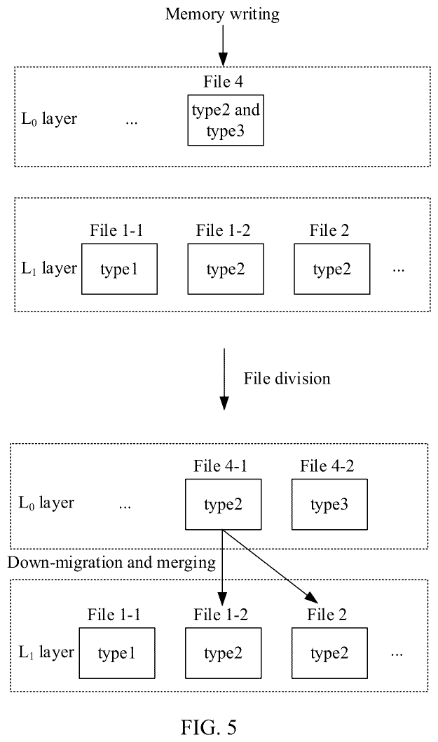

FIG. 5 is a schematic diagram of another file merging procedure according to an example embodiment. An example in which an LSM tree includes a memory and an L₀ layer and an L₁ layer in a disk is still used. As shown in FIG. 5, in response to writing a file 1 into the L₁ layer, and determining that the file 1 includes data corresponding to a plurality of keys, the file 1 can be divided to obtain a file 1-1 and a file 1-2.

In a shown implementation, if a file is written into the L₀ layer in the disk from the memory, and the file includes data corresponding to a plurality of keys, the file can be divided at the L₀ layer. For example, as shown in FIG. 5, a file 4 includes data whose key is type2 and data whose key is type3. After the file 4 is written into the L₀ layer, the file 4 can be divided to obtain a file 4-1 and a file 4-2. The file 4-1 includes only data whose key is type2, and the file 4-2 includes only data whose key is type3.

Further, in response to the L₀ layer meeting a merge condition, the file 4-1 at the L₀ layer can be selected as a to-be-merged file, and the file 4-1 and the file 1-2 and a file 2 that include data whose key is type2 at the L₁ can be merged. For example, the file 4-1 can be a file with a largest data amount at the L₀ layer, or a key of data included in the file 4-1 is smallest (type2 is less than type3). Therefore, the file 4-1 can be used as the to-be-merged file, and so on. This is not specifically limited in this specification.

In conclusion, this specification is applied to an LSM tree-based data storage system, and an LSM tree can include a plurality of storage layers. At least one first file can be stored at a first storage layer in the plurality of storage layers. A plurality of second sub-files obtained by dividing a second file are stored at a second storage layer in the plurality of storage layers, the second file can include data respectively corresponding to a plurality of types, and each of the plurality of second sub-files obtained through division can include only data corresponding to a same type. First, in this specification, it can be first determined whether the first storage layer meets a merge condition for merging with the second storage layer, and if yes, a to-be-merged target file can be selected from the at least one first file stored at the first storage layer. The target file can include data corresponding to a target type. Further, in this specification, the plurality of second sub-files stored at the second storage layer can be searched for a target sub-file that includes data corresponding to the target type, and a merge operation is performed on the target file and the target sub-file. In this way, in this specification, a file that includes data corresponding to a plurality of types is divided into a plurality of sub-files, and each sub-file includes only data corresponding to a same type. Therefore, in a process of merging an upper-layer file and a lower-layer file in the LSM tree, passive participation of different types of data in merging is effectively avoided, thereby greatly reducing a read/write amplification amount during merging, and improving storage performance.

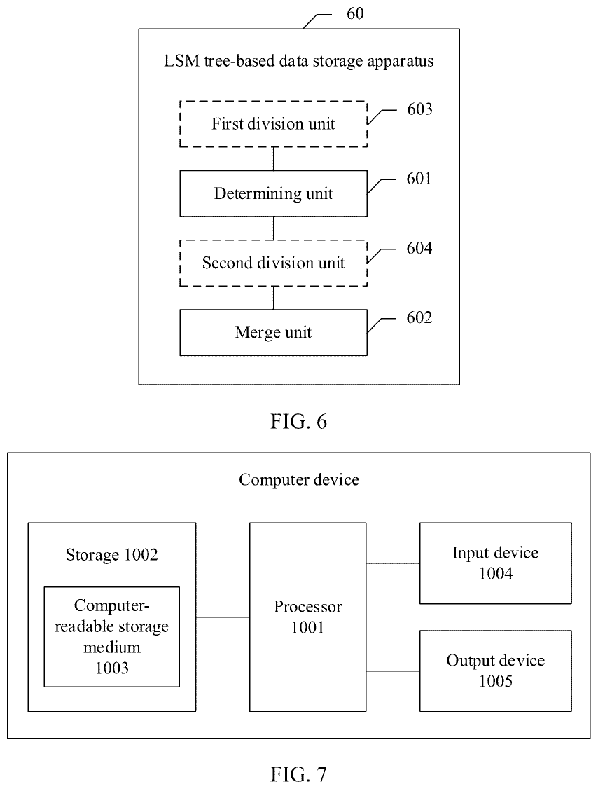

Corresponding to the above-mentioned method procedure implementation, an embodiment of this specification further provides an LSM tree-based data storage apparatus. FIG. 6 is a schematic structural diagram of an LSM tree-based data storage apparatus according to an example embodiment. The apparatus 60 can be applied to the LSM tree-based data storage system shown in FIG. 1, for example, a graph database system. An LSM tree can include a plurality of storage layers. At least one first file can be stored at a first storage layer in the plurality of storage layers. A plurality of second sub-files obtained by dividing a second file can be stored at a second storage layer in the plurality of storage layers. The second file includes data respectively corresponding to a plurality of types, and each of the plurality of second sub-files includes data corresponding to a same type. As shown in FIG. 6, the apparatus 60 includes:
a determining unit 601, configured to: determine whether the first storage layer meets a merge condition for merging with the second storage layer, and if yes, select a to-be-merged target file from the at least one first file stored at the first storage layer, where the target file includes data corresponding to a target type; and
a merge unit 602, configured to: search the plurality of second sub-files stored at the second storage layer for a target sub-file that includes data corresponding to the target type, and merge the target file and the target sub-file.

In a shown implementation, the type is a hot data type or a non-hot data type, and the target type is the hot data type.

In a shown implementation, the data is data of a key-value structure, and a key of the data includes the type.

In a shown implementation, the apparatus 60 further includes a first division unit 603, configured to:
in response to writing the second file into the second storage layer, and the second file including the data respectively corresponding to the plurality of types, divide the second file to obtain the plurality of second sub-files corresponding to the plurality of types.

In a shown implementation, the apparatus 60 further includes a second division unit 604, configured to:
write the second file into the second storage layer, where the second file includes the data respectively corresponding to the plurality of types; and
in response to the selected to-be-merged target file including the data corresponding to the target type, and the plurality of types including the target type, divide the second file to obtain the plurality of second sub-files corresponding to the plurality of types.

In a shown implementation, the first division unit 603 or the second division unit 604 is specifically configured to:
read the data that is included in the second file and that respectively corresponds to the plurality of types; and
generate the plurality of second sub-files corresponding to the plurality of types based on the data respectively corresponding to the plurality of types, and separately write the plurality of second sub-files into the second storage layer.

In a shown implementation, the merge unit 602 is specifically configured to:
read the data that is included in the target file and the target sub-file and that corresponds to the target type; and
delete duplicate data from the data, generate at least one corresponding file based on remaining data in the data, and write the at least one file into the second storage layer, where a data amount included in each of the at least one file is less than or equal to a first preset threshold.

In a shown implementation, the merge condition includes: a total data amount included in the at least one first file stored at the first storage layer is greater than a second preset threshold.

In a shown implementation, the LSM tree-based data storage system includes a graph database system.

For details of implementation processes of functions and roles of the units in the apparatus 60, refer to the descriptions of the embodiments corresponding to FIG. 1 to FIG. 5. Details are not described herein. It should be understood that the apparatus 60 can be implemented by software, or can be implemented by hardware or a combination of software and hardware. Software implementation is used as an example. As a logical apparatus, the apparatus is formed by reading corresponding computer program instructions to a memory by a processor (CPU) of a device in which the apparatus is located. From a hardware perspective, in addition to the CPU and a storage, the device in which the apparatus is located usually further includes other hardware such as a chip used to send and receive wireless signals and/or other hardware such as a board used to implement a network communication function.

The apparatus embodiment described above is merely an example. The units described as separate parts may or may not be physically separate, and parts displayed as units may or may not be physical modules, may be located at one position, or may be distributed on a plurality of network modules. Some or all of the units or modules can be selected based on actual needs to achieve the objectives of the solutions of this specification. A person of ordinary skill in the art can understand and implement the solutions without creative efforts.

The apparatus, unit, and module illustrated in the above-mentioned embodiments can be specifically implemented by a computer chip or an entity, or can be implemented by a product with a certain function. A typical implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, an in-vehicle computer, or a combination of any several of these devices.

Corresponding to the above-mentioned method embodiment, an embodiment of this specification further provides a computer device. FIG. 7 is a schematic structural diagram of a computer device according to an example embodiment. The computer device shown in FIG. 7 can be a computer device in the LSM tree-based data storage system 10 shown in FIG. 2, and an LSM tree includes a plurality of storage layers. At least one first file is stored at a first storage layer in the plurality of storage layers. A plurality of second sub-files obtained by dividing a second file are stored at a second storage layer in the plurality of storage layers, the second file includes data respectively corresponding to a plurality of types, and each of the plurality of second sub-files includes data corresponding to a same type. As shown in FIG. 7, the computer device includes a processor 1001 and a storage 1002, and can further include an input device 1004 (for example, a keyboard or the like) and an output device 1005 (for example, a display or the like). The processor 1001, the storage 1002, the input device 1004, and the output device 1005 can be connected through a bus or in another manner. As shown in FIG. 7, the storage 1002 includes a computer-readable storage medium 1003, and the computer-readable storage medium 1003 stores a computer program that can be run by the processor 1001. The processor 1001 can be a CPU, a microprocessor, or an integrated circuit configured to control execution of the above-mentioned method embodiment. When running the stored computer program, the processor 1001 can perform the steps of the LSM tree-based data storage method in the embodiments of this specification, including: determining whether the first storage layer meets a merge condition for merging with the second storage layer, and if yes, selecting a to-be-merged target file from the at least one first file stored at the first storage layer, where the target file includes data corresponding to a target type; and searching the plurality of second sub-files stored at the second storage layer for a target sub-file that includes data corresponding to the target type, and merging the target file and the target sub-file; and so on.

For detailed descriptions of the steps of the LSM tree-based data storage method, refer to the above-mentioned content. Details are not described herein.

Corresponding to the above-mentioned method embodiment, an embodiment of this specification further provides a non-transitory computer-readable storage medium. The storage medium stores a computer program, and when the computer program is run by a processor, the steps of the LSM tree-based data storage method in the embodiments of this specification are performed. For details, refer to the descriptions of the embodiments corresponding to FIG. 1 to FIG. 5. Details are not described herein.

The above-mentioned descriptions are merely example embodiments of this specification, but are not intended to limit this specification. Any modification, equivalent replacement, improvement, and the like made without departing from the spirit and principle of this specification shall fall within the protection scope of this specification.

In a typical configuration, a terminal device includes one or more CPUs, input/output interfaces, network interfaces, and memories.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data.

Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

It should be further noted that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, the embodiments of this specification can use a form of hardware only embodiments, software only embodiments, or embodiments with a combination of software and hardware. In addition, the embodiments of this specification can use a form of a computer program product that is implemented on one or more computer-usable storage media (including but not limited to a disk storage, a CD-ROM, an optical storage, or the like) that include computer-usable program code.

1. An LSM tree-based data storage method, applied to an LSM tree-based data storage system, wherein an LSM tree comprises a plurality of storage layers; at least one first file is stored at a first storage layer in the plurality of storage layers; a plurality of second sub-files obtained by dividing a second file are stored at a second storage layer in the plurality of storage layers, the second file comprises data respectively corresponding to a plurality of types, and each of the plurality of second sub-files comprises data corresponding to a same type; and the method comprises:
determining whether the first storage layer meets a merge condition for merging with the second storage layer, and if yes, selecting a to-be-merged target file from the at least one first file stored at the first storage layer, wherein the target file comprises data corresponding to a target type; and
searching the plurality of second sub-files stored at the second storage layer for a target sub-file that comprises data corresponding to the target type, and merging the target file and the target sub-file.

2. The method according to claim 1, wherein each type of the plurality of types is a hot data type or a non-hot data type, and the target type is the hot data type.

3. The method according to claim 1, wherein the data is data of a key-value structure, and a key of the data comprises a corresponding type in the plurality of types.

4. The method according to claim 1, wherein the method further comprises:
in response to writing the second file into the second storage layer, and the second file comprising the data respectively corresponding to the plurality of types, dividing the second file to obtain the plurality of second sub-files corresponding to the plurality of types.

5. The method according to claim 1, wherein the method further comprises:
writing the second file into the second storage layer, wherein the second file comprises the data respectively corresponding to the plurality of types; and
in response to the selected to-be-merged target file comprising the data corresponding to the target type, and the plurality of types comprising the target type, dividing the second file to obtain the plurality of second sub-files corresponding to the plurality of types.

6. The method according to claim 4, wherein the dividing the second file to obtain the plurality of second sub-files corresponding to the plurality of types comprises:
reading the data that is comprised in the second file and that respectively corresponds to the plurality of types; and
generating the plurality of second sub-files corresponding to the plurality of types based on the data respectively corresponding to the plurality of types, and separately writing the plurality of second sub-files into the second storage layer.

7. The method according to claim 1, wherein the merging the target file and the target sub-file comprises:
reading the data that is comprised in the target file and the target sub-file and that corresponds to the target type; and
deleting duplicate data from the data, generating at least one corresponding file based on remaining data in the data, and writing the at least one file into the second storage layer, wherein a data amount comprised in each of the at least one file is less than or equal to a first preset threshold.

8. The method according to claim 1, wherein the merge condition comprises: a total data amount comprised in the at least one first file stored at the first storage layer is greater than a second preset threshold.

9. The method according to claim 1, wherein the LSM tree-based data storage system comprises a graph database system.

10. A computer device, applied to an LSM tree-based data storage system, comprising a memory and a processor, wherein an LSM tree comprises a plurality of storage layers; at least one first file is stored at a first storage layer in the plurality of storage layers; a plurality of second sub-files obtained by dividing a second file are stored at a second storage layer in the plurality of storage layers, the second file comprises data respectively corresponding to a plurality of types, and each of the plurality of second sub-files comprises data corresponding to a same type, wherein the memory stores a computer program capable of being run by the processor, and when the processor runs the computer program, the processor is caused to:
determine whether the first storage layer meets a merge condition for merging with the second storage layer, and if yes, selecting a to-be-merged target file from the at least one first file stored at the first storage layer, wherein the target file comprises data corresponding to a target type; and
search the plurality of second sub-files stored at the second storage layer for a target sub-file that comprises data corresponding to the target type, and merging the target file and the target sub-file.

11. The computer device according to claim 10, wherein each type of the plurality of types is a hot data type or a non-hot data type, and the target type is the hot data type.

12. The computer device according to claim 10, wherein the data is data of a key-value structure, and a key of the data comprises a corresponding type in the plurality of types.

13. The computer device according to claim 10, wherein the computer device is further caused to:
in response to writing the second file into the second storage layer, and the second file comprising the data respectively corresponding to the plurality of types, divide the second file to obtain the plurality of second sub-files corresponding to the plurality of types.

14. The computer device according to claim 10, wherein the computer device is further caused to:
write the second file into the second storage layer, wherein the second file comprises the data respectively corresponding to the plurality of types; and
in response to the selected to-be-merged target file comprising the data corresponding to the target type, and the plurality of types comprising the target type, divide the second file to obtain the plurality of second sub-files corresponding to the plurality of types.

15. The computer device according to claim 13, wherein the computer device being caused to divide the second file to obtain the plurality of second sub-files corresponding to the plurality of types includes being caused to:
read the data that is comprised in the second file and that respectively corresponds to the plurality of types; and
generate the plurality of second sub-files corresponding to the plurality of types based on the data respectively corresponding to the plurality of types, and separately writing the plurality of second sub-files into the second storage layer.

16. The computer device according to claim 10, wherein the computer device being caused to merge the target file and the target sub-file includes being caused to:
read the data that is comprised in the target file and the target sub-file and that corresponds to the target type; and
delete duplicate data from the data, generating at least one corresponding file based on remaining data in the data, and writing the at least one file into the second storage layer, wherein a data amount comprised in each of the at least one file is less than or equal to a first preset threshold.

17. The computer device according to claim 10, wherein the merge condition comprises:
a total data amount comprised in the at least one first file stored at the first storage layer is greater than a second preset threshold.

18. The computer device according to claim 10, wherein the LSM tree-based data storage system comprises a graph database system.

19. A non-transitory computer-readable storage medium, applied to an LSM tree-based data storage system, wherein an LSM tree comprises a plurality of storage layers; at least one first file is stored at a first storage layer in the plurality of storage layers; a plurality of second sub-files obtained by dividing a second file are stored at a second storage layer in the plurality of storage layers, the second file comprises data respectively corresponding to a plurality of types, and each of the plurality of second sub-files comprises data corresponding to a same type, wherein the non-transitory computer-readable storage medium stores a computer program, and when the computer program is executed by a processor, the processor is caused to:
determine whether the first storage layer meets a merge condition for merging with the second storage layer, and if yes, selecting a to-be-merged target file from the at least one first file stored at the first storage layer, wherein the target file comprises data corresponding to a target type; and
search the plurality of second sub-files stored at the second storage layer for a target sub-file that comprises data corresponding to the target type, and merging the target file and the target sub-file.

20. The non-transitory computer-readable storage medium according to claim 19, wherein each type of the plurality of types is a hot data type or a non-hot data type, and the target type is the hot data type.
